(19) United States
(12) Patent Application Publication
(10) Pub. No.: US 2026/0125567 A1
(43) Pub. Date: May 7, 2026

(54) Dye Composition, Method Of Producing Dye Composition, Ink Jet Ink Composition, And Method Of Forming Recorded Material

(71) Applicant: SEIKO EPSON CORPORATION, Tokyo (JP)

(72) Inventor: Yuta ASAKAWA, Azumino (JP)

(21) Appl. No.: 19/375,419

(22) Filed: Oct. 31, 2025

(30) Foreign Application Priority Data
Nov. 1, 2024 (JP) 2024-192592

(51) Int. Cl. C09D 11/30; B41M 5/025; C09B 67/20; C09D 11/102

(52) U.S. Cl. CPC C09D 11/30; B41M 5/0256; C09B 67/0066; C09D 11/102; B41M 2205/02; B41M 2205/06; B41M 2205/10

(57) ABSTRACT

A dye composition includes: a water-insoluble dye; a specific dispersant for dispersing the water-insoluble dye; an alkylene oxide adduct of (poly)glycerin; and water, in which the specific dispersant contains a copolymer of a styrene compound and maleic acid, or a urethane resin, the alkylene oxide adduct of (poly)glycerin contains a propylene oxide group, a ratio (B/A) of a content B of the specific dispersant to a content A of the water-insoluble dye is 0.40 to 0.75, and a content of the alkylene oxide adduct of (poly)glycerin is 0.05 to 1.00 mass % with respect to a total amount of the dye composition.

The present application is based on, and claims priority from JP Application Serial Number 2024-192592, filed Nov. 1, 2024, the disclosure of which is hereby incorporated by reference herein in its entirety.

### BACKGROUND

### 1. Technical Field

The present disclosure relates to a dye composition, a method of producing a dye composition, an ink jet ink composition, and a method of forming a recorded material.

### 2. Related Art

An ink jet recording method can record a high-definition image with a relatively simple apparatus and has been rapidly developed in various fields. Among them, various studies have been made on storage stability and the like. For example, JP-A-2018-150400 discloses an ink composition containing a lactone-structured organic acid, a colorant, and a styrene-(meth)acrylic copolymer or diglycerin.

Meanwhile, from the viewpoint of improving printing accuracy, it is preferable that the ink jet ink composition be stably ejected from an ink jet head. In addition, since the ink jet ink composition is stored at a high temperature depending on the environment in which an ink jet printer is installed, it is preferable that the properties of the ink jet ink composition do not change even at a high temperature. That is, it is preferable that the ink jet ink composition have good ejection stability and storage stability at a high temperature.

### SUMMARY

According to an aspect of the present disclosure, there is provided a dye composition including: a water-insoluble dye; a specific dispersant for dispersing the water-insoluble dye; an alkylene oxide adduct of (poly)glycerin; and water, in which the specific dispersant contains a copolymer of a styrene compound and maleic acid, or a urethane resin, the alkylene oxide adduct of (poly)glycerin contains a propylene oxide group, a ratio (B/A) of a content B of the specific dispersant to a content A of the water-insoluble dye is 0.40 to 0.75, and a content of the alkylene oxide adduct of (poly)glycerin is 0.05 to 1.00 mass % with respect to a total amount of the dye composition.

### BRIEF DESCRIPTION OF THE DRAWINGS

FIG. 1 is a schematic view of a recording apparatus that is used in an embodiment.

FIG. 2 is a table showing results of Examples.

FIG. 3 is a table showing results of Examples.

### DESCRIPTION OF EMBODIMENTS

Hereinafter, an embodiment of the present disclosure (hereinafter, referred to as “the present embodiment”) will be described in detail. However, the present disclosure is not limited thereto, and various modifications can be made without departing from the gist thereof.

### 1. Dye Composition

A dye composition of the present embodiment is a dye composition including: a water-insoluble dye; a specific dispersant for dispersing the water-insoluble dye; an alkylene oxide adduct of (poly)glycerin; and water, in which the specific dispersant contains a copolymer of a styrene compound and maleic acid, or a urethane resin, the alkylene oxide adduct of (poly)glycerin contains a propylene oxide group, a ratio (B/A) of a content B of the specific dispersant to a content A of the water-insoluble dye is 0.40 to 0.75, and a content of the alkylene oxide adduct of (poly)glycerin is 0.05 to 1.00 mass % with respect to a total amount of the dye composition.

When a water-based ink is produced by dispersing the water-insoluble dye in water, a dispersant for dispersing the water-insoluble dye in water is usually used. However, since the water-insoluble dye dispersed by the dispersant (hereinafter, also referred to as “dispersed water-insoluble dye”) is easily dissolved, particularly in a high-temperature environment, in an organic solvent or a surfactant which may be contained in the water-based ink, there is room for improvement in the storage stability at a high temperature of the water-based ink having the dispersed water-insoluble dye. In addition, since the dispersed water-insoluble dye has a large specific surface area, when air bubbles are mixed into the water-based ink having the dispersed water-insoluble dye, the ejection stability of the ink is likely to deteriorate. Furthermore, in order to prevent the water-based ink having the dispersed water-insoluble dye from sticking to nozzles for ejecting the ink, it is preferable that the ink be easily redissolved in a solvent after solidification.

In this regard, the dye composition of the present embodiment can exhibit excellent storage stability even at a high temperature by using the specific dispersant containing a copolymer of a styrene compound and maleic acid, or a urethane resin, in combination with the alkylene oxide adduct of (poly)glycerin. Since the storage stability at a high temperature of the dye composition is excellent, it can be said that the storage stability at a high temperature of the ink jet ink composition containing the dye composition is also excellent. In addition, by using the specific dispersant and the alkylene oxide adduct of (poly)glycerin in combination, ejection stability and redissolvability can also be improved.

The specific dispersant containing a copolymer of a styrene compound and maleic acid, or a urethane resin, is adsorbed on the surface of the water-insoluble dye to disperse the water-insoluble dye in water. At this time, the hydrophilic group of the specific dispersant is oriented to the solvent side, and dispersibility is imparted by steric hindrance or electrostatic repulsion due to the orientation. Since the specific dispersant used in the present embodiment is easily adsorbed on the surface of the water-insoluble dye and has high hydrophilicity, it is possible to sufficiently disperse the water-insoluble dye by the specific dispersant while preventing, even in a high-temperature environment, the specific dispersant from being detached from the surface of the water-insoluble dye or the water-insoluble dye from being dissolved in an organic solvent or a surfactant.

Furthermore, when the ratio (B/A) of the content B of the specific dispersant to the content A of the water-insoluble dye is 0.40 to 0.75, the water-insoluble dye tends to be more easily dispersed even in a high-temperature environment.

A predetermined amount of the alkylene oxide adduct of (poly)glycerin has a hydrophilic (poly)glycerin structure and a propylene oxide group which is slightly hydrophobic. Accordingly, it is considered that the alkylene oxide adduct of (poly)glycerin can improve the compatibility of the specific dispersant with water, improve the dispersibility of the water-insoluble dye in a high-temperature environment, and improve the storage stability.

Furthermore, when the content of the alkylene oxide adduct of (poly)glycerin is 0.05 to 1.00 mass % with respect to the total amount of the dye composition, the dispersibility of the water-insoluble dye dispersed by the specific dispersant tends to be improved even in a high-temperature environment.

From the above factors, it is presumed that the storage stability at a high temperature of the dye composition of the present embodiment is improved by the specific dispersant and the alkylene oxide adduct of (poly)glycerin, but the factors are not limited thereto.

In the present embodiment, the alkylene oxide adduct of (poly)glycerin has a propylene oxide group, and the propylene oxide group has appropriate hydrophobicity. Therefore, the alkylene oxide adduct of (poly)glycerin easily permeates into the water-insoluble dye dispersed by the specific dispersant. As a result, the mixed air bubbles are less likely to be incorporated into the dispersed water-insoluble dye and are easily removed. As a result, the ejection stability of the ink jet ink composition containing the dye composition of the present embodiment tends to be improved.

In addition, since the specific dispersant has high hydrophilicity, the dye composition of the present embodiment is easily redissolved in water after solidification. That is, the dye composition of the present embodiment containing the specific dispersant tends to have high redissolvability. Since the redissolvability of the dye composition is excellent, it can be said that the redissolvability of the ink jet ink composition containing the dye composition is also excellent.

In addition, since the specific dispersant has low volatility, when the ink jet ink composition containing the dye composition of the present embodiment is heated in a sublimation transfer printing method to be described later, the odor tends to be weak.

It is preferable that the dye composition of the present embodiment be contained in an ink jet ink composition which is ejected from an ink jet head of an ink jet recording apparatus to be described later.

Hereinafter, each component which may be contained in the dye composition of the present embodiment will be described in detail.

### 1.1. Water-Insoluble Dye

The water-insoluble dye of the present embodiment dissolves in an amount of 1 g or less in water of 1 L at 25° C. Examples of such water-insoluble dyes include a disperse dye and a solvent dye. The disperse dye and the solvent dye are dyes that are dispersed in water by a dispersant to be described later. The disperse dye and the solvent dye are dyes soluble in organic solvents such as ethanol and acetone. In the dye composition of the present embodiment, it is preferable that the water-insoluble dye be dispersed.

Examples of the method of causing a dye to adhere to a material to be dyed include a method of directly causing a dye to adhere to a material to be dyed, and a method of causing a dye to adhere to an intermediate recording medium, superimposing the intermediate recording medium to which the dye has adhered on a material to be dyed to obtain a laminate, and heating the laminate to sublimate the dye and cause the dye to adhere to the material to be dyed (hereinafter, this method is also referred to as “sublimation transfer printing method”). The dye composition of the present embodiment is preferably contained in an ink composition to be caused to adhere to the intermediate recording medium in the sublimation transfer printing method. In the sublimation transfer printing method, it is preferable that the water-insoluble dye be easily sublimated. From this viewpoint, it is preferable that the water-insoluble dye of the present embodiment have a molecular weight of 500 or less. Alternatively, it is preferable that the water-insoluble dye be a disperse dye having a molecular weight of 500 or less or a solvent dye having a molecular weight of 500 or less. The water-insoluble dye having a molecular weight of 500 or less is generally easily dissolved by an organic solvent or a surfactant. In this regard, since the dye composition of the present embodiment contains the specific dispersant and the alkylene oxide adduct of (poly)glycerin having a propylene oxide group, in the present embodiment, the water-insoluble dye having a molecular weight of 500 or less tends not to be easily dissolved by an organic solvent or a surfactant.

It is preferable that the water-insoluble dye of the present embodiment be sublimated by heating. The sublimation temperature is preferably 120° C. or higher, 140° C. or higher, or 160° C. or higher. The upper limit of the sublimation temperature is not particularly limited, but is, for example, 220° C. or lower, and preferably 200° C. or lower.

The disperse dye that sublimates when heated is not particularly limited, and examples thereof include: C.I. Disperse Yellow 3, 7, 8, 23, 39, 51, 54, 60, 64, 71, 82, 86, 211, and 232; C.I. Disperse Orange 1, 1:1, 5, 20, 24, 25, 25:1, 33, 56, and 76; C.I. Disperse Brown 2 and 27; C.I. Disperse Red 11, 50, 53, 55, 55:1, 59, 60, 65, 70, 75, 93, 146, 158, 190, 190:1, 207, 239, 240, and 364; C.I. Disperse Violet 8, 17, 23, 27, 28, 29, 36, and 57; and C.I. Disperse Blue 14, 19, 26, 26:1, 35, 55, 56, 58, 64, 64:1, 72, 72:1, 81, 81:1, 91, 95, 108, 131, 141, 145, 359, and 360.

The solvent dye that sublimates when heated is not particularly limited, and examples thereof include C.I. Solvent Blue 36, 63, 94, 105, and 111.

The content of the water-insoluble dye is preferably 5.0 to 30.0 mass %, 7.5 to 25.0 mass %, or 10.0 to 20.0 mass % with respect to the total amount of the dye composition. When the content of the water-insoluble dye is within the above range, the ejection stability of the ink jet ink composition containing the dye composition tends to be further improved.

### 1.2. Dispersant

The dispersant has a function of dispersing the water-insoluble dye in water. The dye composition of the present embodiment contains, as a dispersant, a specific dispersant containing a copolymer of a styrene compound and maleic acid, or a urethane resin, and may contain a dispersant other than the specific dispersant, if necessary. Since the specific dispersant is a polymer-based dispersant, the odor of the dye composition tends to be reduced compared to, for example, a relatively low-molecular-weight dispersant such as a formalin condensate of sodium naphthalenesulfonate.

### 1.2.1. Specific Dispersant

The copolymer of the styrene compound and maleic acid, which is the specific dispersant, has a constituent unit derived from the styrene compound and a constituent unit derived from the maleic acid. Examples of the styrene compound include styrene and a modified styrene. The modified styrene is a compound in which hydrogen directly bonded to carbon constituting a benzene ring of styrene is replaced with another functional group. The modified styrene is not particularly limited, and examples thereof include chlorostyrene, fluorostyrene, phenylstyrene, methylstyrene, ethylstyrene, carboxystyrene, and polyoxyalkylene styrene. As the styrene compound, one type of styrene compound may be used alone, or two or more types of styrene compounds may be used in combination. As the maleic acid, in addition to maleic acid, maleic anhydride may be used, or an esterified product of maleic acid may be used.

As the copolymer of the styrene compound and maleic acid, which is the specific dispersant, a copolymer produced by copolymerizing a styrene compound and maleic acid may be used, or a commercially available product may be used. Commercially available products are not particularly limited, and examples thereof include: DISPERBYK-190 and DISPERBYK-2015 (trade names, manufactured by BYK Japan KK); TEGO Dispers 750W and TEGO Dispers 755W (trade names, manufactured by Evonik Japan Co., Ltd.); and NOPCOSPERSE 6100 (trade name, manufactured by SAN NOPCO LIMITED).

The urethane resin which is the specific dispersant is a resin having a urethane bond. The urethane resin is obtained, for example, by copolymerizing a polyvalent isocyanate and a polyhydric alcohol, and has a constitutional unit derived from the polyvalent isocyanate and a constitutional unit derived from the polyhydric alcohol.

The polyvalent isocyanate is not particularly limited, and examples thereof include an aliphatic polyvalent isocyanate and an aromatic polyvalent isocyanate. The aliphatic polyvalent isocyanate is not particularly limited, and examples thereof include: polyvalent isocyanates having a chain structure such as tetramethylene diisocyanate, dodecamethylene diisocyanate, hexamethylene diisocyanate, 2,2,4-trimethylhexamethylene diisocyanate, 2,4,4-trimethylhexamethylene diisocyanate, lysine diisocyanate, 2-methylpentane-1,5-diisocyanate, and 3-methylpentane-1,5-diisocyanate; and polyvalent isocyanates having a cyclic structure such as isophorone diisocyanate, hydrogenated xylylene diisocyanate, 4,4′-dicyclohexylmethane diisocyanate, 1,4-cyclohexane diisocyanate, methylcyclohexylene diisocyanate, and 1,3-bis(isocyanatomethyl)cyclohexane. As the aliphatic polyvalent isocyanate, one type of aliphatic polyvalent isocyanate may be used alone, or two or more types of aliphatic polyvalent isocyanates may be used in combination.

The aromatic polyvalent isocyanate is not particularly limited, and examples thereof include tolylene diisocyanate, 2,2′-diphenylmethane diisocyanate, 2,4′-diphenylmethane diisocyanate, 4,4′-diphenylmethane diisocyanate, 4,4′-dibenzyl diisocyanate, 1,5-naphthylene diisocyanate, xylylene diisocyanate, 1,3-phenylene diisocyanate, 1,4-phenylene diisocyanate, dialkyldiphenylmethane diisocyanate, tetraalkyldiphenylmethane diisocyanate, and α,α, α′,α′-tetramethylxylylene diisocyanate. As the aromatic polyvalent isocyanate, one type of aromatic polyvalent isocyanate may be used alone, or two or more types of aromatic polyvalent isocyanates may be used in combination.

The polyhydric alcohol is not particularly limited, and examples thereof include ethylene glycol, 1,2-propylene glycol, 1,3-propylene glycol, 1,3-propanediol, 1,3-butylene glycol, 1,4-butanediol, 1,6-hexanediol, 2-methyl-1,5-pentanediol, neopentyl glycol, 1,4-cyclohexanedimethanol, p-xylylene glycol, bisphenol A-ethylene glycol adduct, diethylene glycol, triethylene glycol, polyethylene glycol, polypropylene glycol, polytetramethylene glycol, polytetramethylene oxide glycol, dimethylolpropionic acid, glycerin, trimethylolpropane, sodium dimethylolethylsulfonate, potassium dimethylolethylsulfonate, and potassium dimethylolpropionate. As the polyhydric alcohol, one type of polyhydric alcohol may be used alone, or two or more types of polyhydric alcohols may be used in combination.

As the urethane resin which is the specific dispersant, a resin produced by copolymerizing a polyvalent isocyanate and a polyhydric alcohol may be used, or a commercially available product may be used. The commercially available product is not particularly limited, and examples thereof include: Solsperse J400 (trade name, manufactured by Lubrizol Japan Ltd.); and Borchi Gen 0851 and Borchi Gen SN 95 (trade names, manufactured by Borchers GmbH).

The content of the specific dispersant is preferably 2.5 to 11.0 mass %, 5.0 to 10.5 mass %, or 6.5 to 10.0 mass % with respect to the total amount of the dye composition. When the content of the specific dispersant is in the above range, the ejection stability of the ink jet ink composition containing the dye composition and the redissolvability and the storage stability at a high temperature of the dye composition tend to be further improved.

The ratio (B/A) of the content B of the specific dispersant to the content A of the water-insoluble dye is 0.40 to 0.75, and preferably 0.45 to 0.65. When the ratio (B/A) is 0.40 or more, the redissolvability and the storage stability of the dye composition tend to be further improved. In addition, when the ratio (B/A) is 0.75 or less, the ejection stability of the ink jet ink composition containing the dye composition tends to be further improved.

### 1.2.2. Other Dispersants

The dye composition of the present embodiment may have a dispersant other than the specific dispersant from the viewpoint of further improving the dispersibility of the water-insoluble dye in water. Examples of the other dispersant include a surfactant-based dispersant, an inorganic dispersant, and a resin dispersant other than the specific dispersant.

The surfactant-based dispersant is not particularly limited, and examples thereof include: anionic surfactants such as alkanesulfonates, α-olefin sulfonates, alkylbenzenesulfonates, alkylnaphthalenesulfonates, naphthalenesulfonates, acylmethyl taurates, dialkyl sulfosuccinates, alkyl sulfate ester salts, sulfated olefins, polyoxyethylene alkyl ether sulfate ester salts, alkyl phosphate ester salts, polyoxyethylene alkyl ether phosphate ester salts, and monoglyceride phosphate ester salts; amphoteric surfactants such as alkylpyridinium salts, alkylamino acid salts, and alkyldimethylbetaines; and nonionic surfactants such as polyoxyethylene alkyl ethers, polyoxyethylene alkyl phenyl ethers, polyoxyethylene alkyl esters, polyoxyethylene alkylamides, glycerin alkyl esters, and sorbitan alkyl esters. As the surfactant-based dispersant, one type of surfactant-based dispersant may be used alone, or two or more types of surfactant-based dispersants may be used in combination.

The inorganic dispersant is not particularly limited, and examples thereof include tricalcium phosphate, trimagnesium phosphate, basic magnesium carbonate, calcium carbonate, barium sulfate, kaolin, talc, and clay.

The resin dispersant other than the specific dispersant is not particularly limited, and examples thereof include polyvinyl alcohols, polyvinylpyrrolidones, acrylonitriles, vinyl acetate-acrylic acid ester copolymers, acrylic acid ester polymers, styrene-(meth)acrylic acid ester copolymers, styrene-methacrylic acid ester-acrylic acid ester copolymers, styrene-α-methylstyrene-acrylic acid ester copolymers, styrene-sulfonic acid copolymers, vinylnaphthalene-acrylic acid ester copolymers, vinylnaphthalene-maleic acid ester copolymers, vinyl acetate-maleic acid ester copolymers, and vinyl acetate-crotonic acid ester copolymers. As the form of the copolymer, any of a random copolymer, a block copolymer, an alternating copolymer, and a graft copolymer may be used.

The content of the other dispersant is not particularly limited, but is, for example, 1.0 to 10.0 mass % or 2.0 to 5.0 mass % with respect to the total amount of the dye composition.

### 1.3. Alkylene Oxide Adduct of (Poly)Glycerin

The alkylene oxide adduct of (poly)glycerin of the present embodiment is a compound having a structure in which a hydroxyl group of (poly)glycerin and a hydroxyl group of (poly)alkylene glycol are subjected to dehydration condensation, and examples thereof include a compound represented by the following Formula (1). In the following Formula (1), a structure in which ether bonds are formed by the hydroxyl groups at the first position and the third position of monoglycerin is shown, but a structure in which ether bonds are formed by the hydroxyl groups at the first position or the third position and the second position of monoglycerin may also be used.

In the present embodiment, “(poly)glycerin” is a generic term for monoglycerin and polyglycerin, “(poly)alkylene oxide group” is a generic term for a monoalkylene oxide group and a polyalkylene oxide group, and “(poly)alkylene glycol” is a generic term for a monoalkylene glycol and a polyalkylene glycol.

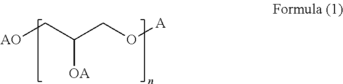

In Formula (1), a plurality of A are each independently a monovalent (poly)alkylene oxide group represented by the following Formula (2) or a hydrogen atom, and at least one of the plurality of A is a monovalent (poly)alkylene oxide group represented by the following Formula (2). n is a natural number, and preferably 1 to 3.

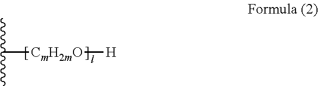

In Formula (2), m is each independently a natural number of 2 to 4, and l is a natural number of 1 to 30. m in the plurality of A may be different from each other. l in the plurality of A may be different from each other.

A group represented by CₘH₂ₘ is not particularly limited, and examples thereof include: linear hydrocarbon groups such as a methylene group, an ethylene group, a propane-1,3-diyl group (also referred to as a propylene group in the present embodiment), and a butane-1,4-diyl group (also referred to as a butylene group in the present embodiment); and branched hydrocarbon groups such as a propane-1,2-diyl group and a butane-1,2-diyl group.

In one molecule, the structure of the (poly)alkylene oxide group may be different for each A. In the (poly)alkylene oxide group, each repeating unit (CₘH₂ₘO) may have a different structure.

The alkylene oxide adduct of (poly)glycerin of the present embodiment has at least a propylene oxide group (C₃H₆O) as a repeating unit constituting the (poly)alkylene oxide group. As a result, for example, the occurrence of dispersion breakdown can be suppressed as compared with a case where all the components are ethylene oxide adducts.

The average number of moles of propylene oxide groups added in the alkylene oxide adduct of (poly)glycerin of the present embodiment is preferably 9 or less, 1 to 9, 1 to 7, 1 to 5, or 1 to 3. When the average number of moles added is within the above range, the storage stability at a high temperature of the dye composition tends to be further improved.

Note that the number of specific alkylene oxide groups in the alkylene oxide adduct of (poly)glycerin is also referred to as the number of moles added. The average of the number of moles added in each alkylene oxide adduct of (poly)glycerin is also referred to as the average number of moles added. That is, the average number of moles of the specific alkylene oxide group added in the dye composition is conceptually calculated by the following Formula (α). Such an average number of moles added may be determined by NMR, MS, or the like.

[average number of moles of specific alkylene oxide groups added]=[total number of specific alkylene oxide groups in all alkylene oxide adducts of (poly)glycerin]/[total number of alkylene oxide adducts of (poly)glycerin] Formula (α)

For example, in a case where an alkylene oxide adduct of glycerin in which the number of moles of the propylene oxide group added is 3 moles and an alkylene oxide adduct of glycerin in which the number of moles of the propylene oxide group added is 5 moles are mixed at 1:1 (molar ratio), the average number of moles of the propylene oxide group added in the alkylene oxide adduct of (poly)glycerin contained in the dye composition is 4 moles.

In the above Formula (1), n is preferably 1 or 2, and more preferably 1. m is preferably 3. l is preferably 1 to 20, 1 to 10, 1 to 5, 1 to 4, 1 to 3, or 1 or 2.

When the plurality of A in Formula (1) are monovalent (poly)alkylene oxide groups represented by Formula (2), the sum of 1 in Formula (1) is preferably 9 or less, 1 to 9, 1 to 7, 1 to 5, or 1 to 3.

When all A in Formula (1) are monovalent (poly)alkylene oxide groups represented by Formula (2) where m=3, the compound represented by Formula (1) is referred to as a propylene oxide adduct of (poly)glycerin, and when all A are monovalent (poly)alkylene oxide groups represented by Formula (2) where m=2, the compound represented by Formula (1) is referred to as an ethylene oxide adduct of (poly)glycerin. When n=1 in Formula (1), the compound represented by Formula (1) is referred to as an alkylene oxide adduct of glycerin, and when n=2, the compound represented by Formula (1) is referred to as an alkylene oxide adduct of diglycerin.

The alkylene oxide adduct of (poly)glycerin having a propylene oxide group of the present embodiment is not particularly limited, and examples thereof include a propylene oxide adduct of glycerin, a propylene oxide adduct of diglycerin, and an alkylene oxide adduct of glycerin having a propylene oxide group.

Specific examples of the propylene oxide adduct of glycerin include: SANNIX GP-250 (average number of moles of PO added: 3), SANNIX GP-400 (average number of moles of PO added: 6), SANNIX GP-600 (average number of moles of PO added: 9), SANNIX GP-1000 (average number of moles of PO added: 16), and SANNIX GP-4000 (average number of moles of PO added: 67) (trade names, manufactured by Sanyo Chemical Industries, Ltd.); ADEKA NOL TP-6 (average number of moles of PO added: 6), ADEKA NOL TP-10 (average number of moles of PO added: 10), and ADEKA NOL TP-24 (average number of moles of PO added: 24) (trade names, manufactured by ADEKA CORPORATION); and UNIOL TG-330 (average number of moles of PO added: 4), UNIOL SGP-65 (average number of moles of PO added: 8), UNIOL TG-700 (average number of moles of PO added: 10), UNIOL TG-1000R (average number of moles of PO added: 16), UNIOL TG-3000 (average number of moles of PO added: 50), and UNIOL TG-4000 (average number of moles of PO added: 70) (trade names, manufactured by NOF CORPORATION).

Specific examples of the propylene oxide adduct of diglycerin include: NIKKOL SG-DG900P (average number of moles of PO added: 9) (trade name, manufactured by Nikko Chemicals Co., Ltd.); SC-P750 (average number of moles of PO added: 9), SC-P1000 (average number of moles of PO added: 14), and SC-P1600 (average number of moles of PO added: 24) (trade names, manufactured by Sakamoto Yakuhin Kogyo Co., Ltd.); and UNILUB DGP-700F (average number of moles of PO added: 9) and UNILUB DGP-950 (average number of moles of PO added: 14) (trade names, manufactured by NOF CORPORATION).

Specific examples of the alkylene oxide adduct of glycerin having a propylene oxide group include: UNILUB 50TG-32 (average number of moles of EO added: 24, and average number of moles of PO added: 24) and WILBRIDE S-753 (average number of moles of EO added: 8, average number of moles of PO added: 5, and average number of moles of BO added: 3) (trade names, manufactured by NOF CORPORATION); NIKKOL SG-G2424 (average number of moles of EO added: 24, and average number of moles of PO added: 24) (trade name, manufactured by Nikko Chemicals Co., Ltd.); FROTHMEISTER GC-48 (average number of moles of EO added: 24, and average number of moles of PO added: 24) (trade name, manufactured by Sanyo Chemical Industries, Ltd.); ADEKA NOL TPE-2424 (average number of moles of EO added: 24, and average number of moles of PO added: 24) (trade name, manufactured by ADEKA CORPORATION); and the like.

Note that the average number of moles of PO added represents the average number of moles of propylene oxide groups added, the average number of moles of EO added represents the average number of moles of ethylene oxide groups added, and the average number of moles of BO added represents the average number of moles of butylene oxide groups added.

The content of the alkylene oxide adduct of (poly)glycerin is 0.05 to 1.00 mass %, preferably 0.06 to 0.90 mass %, 0.07 to 0.80 mass %, 0.08 to 0.70 mass %, 0.09 to 0.60 mass %, 0.10 to 0.50 mass %, 0.15 to 0.45 mass %, or 0.20 to 0.40 mass % with respect to the total amount of the dye composition. When the content of the alkylene oxide adduct of (poly)glycerin is within the above range, the water-insoluble dye dispersed by the dispersant of the present embodiment is easily dispersed in water, and the storage stability of the dye composition at a high temperature tends to be further improved.

The ratio (B/C) of the content B of the specific dispersant to the content C of the alkylene oxide adduct of (poly)glycerin is preferably 5.0 to 50.0, 10.0 to 40.0, 15.0 to 30.0, or 17.5 to 27.5. When the ratio (B/C) is within the above range, the redissolvability of the dye composition and the storage stability at a high temperature are further improved, and the ejection stability of the ink jet ink composition containing the dye composition tends to be further improved.

### 1.4. Defoaming Agent

The dye composition of the present embodiment may contain a defoaming agent. The defoaming agent has a function of suppressing the generation of bubbles in the dye composition. Examples of the defoaming agent include specific defoaming agents including an acetylene glycol-based defoaming agent and/or a silicone-based defoaming agent, and other defoaming agents. As the defoaming agent, a surfactant having an HLB value of 6 or less may be used. Here, the HLB value is a value representing the balance between the hydrophobicity and the hydrophilicity of the surfactant, and the smaller the HLB value, the more hydrophobic the surfactant, and the larger the HLB value, the more hydrophilic the surfactant. In the present disclosure, the HLB value is calculated by, for example, the Griffin method.

### 1.4.1. Specific Defoaming Agent

When the dye composition of the present embodiment contains the specific defoaming agent, the generation of bubbles in the dye composition is suppressed, and as a result, the ejection stability of the ink jet ink composition containing the dye composition tends to be further improved.

The acetylene glycol-based defoaming agent which is the specific defoaming agent is not particularly limited, and examples thereof include SURFYNOL DF110D, SURFYNOL DF37, SURFYNOL 104PG50, SURFYNOL 82, EnviroGem AD-01, OLFINE SPC, OLFINE AF-103, OLFINE AF-104, and OLFINE D-10PG (trade names, manufactured by Nissin Chemical Industry Co., Ltd.).

The silicone-based defoaming agent which is the specific defoaming agent is not particularly limited, and examples thereof include: KM-89, KM-98, KS-540, and X-50-1176 (trade names, manufactured by Shin-Etsu Chemical Co., Ltd.); FC2913, SILFOAM SE47, SILFOAM SD670, and SILFOAM SD850 (trade names, manufactured by Wacker Asahikasei Silicone Co., Ltd.); and BYK-015, BYK-019, BYK-025, BYK-1640, and BYK-1770 (trade names, manufactured by BYK Japan KK).

The content of the specific defoaming agent is preferably 0.10 mass % or less, 0.00 to 0.10 mass %, 0.01 to 0.08 mass %, or 0.02 to 0.06 mass % with respect to the total amount of the dye composition. When the content of the specific defoaming agent is in the above range, the ejection stability of the ink jet ink composition containing the dye composition tends to be further improved.

### 1.4.2. Other Defoaming Agents

The dye composition of the present embodiment may contain a defoaming agent other than the specific defoaming agent from the viewpoint of suppressing the generation of bubbles in the dye composition. The other defoaming agent is not particularly limited, and examples thereof include a polyether-based defoaming agent and a fatty acid ester-based defoaming agent.

The content of the other defoaming agent is not particularly limited, but is, for example, 0.01 to 1.00 mass % with respect to the total amount of the dye composition.

### 1.5. Water

The dye composition of the present embodiment contains water. The water is not particularly limited, and may be, for example, pure water or ion-exchanged water. The content of water is preferably 60 to 90 mass % or 65 to 85 mass % with respect to the total amount of the dye composition. When the content of water is within the above range, the ejection stability of the ink jet ink composition containing the dye composition tends to be further improved, and the storage stability at a high temperature of the dye composition tends to be further improved.

### 1.6. Method of Producing Dye Composition

A method of producing the dye composition of the present embodiment includes a dispersion step of dispersing a water-insoluble dye in water by mixing the water-insoluble dye, a specific dispersant for dispersing the water-insoluble dye, an alkylene oxide adduct of (poly)glycerin, and water.

The method of mixing the above-described raw materials is not particularly limited, and examples thereof include a method in which the above-described raw materials are sealed in the same container and then mixed by using a planetary ball mill, a rocking mill, a wet bead mill, or a dry bead mill, a manual stirring and mixing method, or the like.

The method of producing the dye composition of the present embodiment may further include a filtration step of filtering the mixed liquid in order to remove coarse particles generated after the dispersion step. The method of performing the filtration step is not particularly limited, and examples thereof include a method of passing the mixed liquid after the dispersion step through a mesh filter.

### 2. Ink Jet Ink Composition

An ink jet ink composition of the present embodiment contains the dye composition described above. The ink jet ink composition of the present embodiment may further contain a surfactant and other additives. The content of the dye composition is preferably 20 to 50 mass % or 25 to 45 mass % with respect to the total amount of the ink jet ink composition. When the content of the dye composition is within the above range, the coloring properties and the ejection stability of the ink jet ink composition tend to be improved. Hereinafter, materials other than the dye composition which can be contained in the ink jet ink composition of the present embodiment will be described in detail.

### 2.1. Surfactant

When the ink jet ink composition of the present embodiment contains the surfactant, the generation of bubbles in the ink composition is suppressed, and the ejection stability of the ink jet ink composition tends to be improved. As the surfactant, a silicone-based surfactant and an acetylene glycol-based surfactant are preferable, and the silicone-based surfactant is more preferable. Since the silicone-based surfactant tends to foam largely, it is preferable that the silicone-based surfactant be contained in the ink jet ink composition containing the dye composition rather than being added to the dye composition.

The acetylene glycol-based surfactant is not particularly limited, and examples thereof include: alkylene oxide adducts of 2,4,7,9-tetramethyl-5-decyne-4,7-diol and 2,4,7,9-tetramethyl-5-decyne-4,7-diol; and alkylene oxide adducts of 2,4-dimethyl-5-decyne-4-ol and 2,4-dimethyl-5-decyne-4-ol. Commercially available products of the acetylene glycol-based surfactants are not particularly limited, and examples thereof include OLFINE 104 series, OLFINE E series such as E1010, and SURFYNOL 104, 465, 485, 61, and DF110D (trade names, manufactured by Nissin Chemical Industry Co., Ltd.). As the acetylene glycol-based surfactant, one type of acetylene glycol-based surfactant may be used alone, or two or more types of acetylene glycol-based surfactants may be used in combination.

The silicone-based surfactant is not particularly limited, and examples thereof include polysiloxane-based compounds and polyether-modified organosiloxanes. Commercially available silicone-based surfactants are not particularly limited, and specific examples thereof include: SILFACE SAG503A (trade name, manufactured by Nissin Chemical Industry Co., Ltd.); BYK-028, BYK-306, BYK-307, BYK-333, BYK-341, BYK-345, BYK-346, BYK-347, BYK-348, and BYK 349 (trade names, manufactured by BYK Japan KK); KF-351A, KF-352A, KF-353, KF-354L, KF-355A, KF-615A, KF-945, KF-640, KF-642, KF-643, KF-6020, X-22-4515, KF-6011, KF-6012, KF-6015, and KF-6017 (trade names, manufactured by Shin-Etsu Chemical Co., Ltd.); and the like. As the silicone-based surfactant, one type of silicone-based surfactant may be used alone, or two or more types of silicone-based surfactants may be used in combination.

The content of the surfactant is preferably 0.05 to 1.00 mass % or 0.10 to 0.50 mass % with respect to the total amount of the ink jet ink composition. When the content of the surfactant is within the above range, the ejection stability of the ink jet ink composition tends to be further improved.

### 2.2. Alkylene Oxide Adduct of (Poly)Glycerin

An alkylene oxide adduct of (poly)glycerin may be further added to the ink jet ink composition of the present embodiment separately from the alkylene oxide adduct of (poly)glycerin contained in the dye composition. In this case, the total amount of the alkylene oxide adducts of (poly)glycerin contained in the ink jet ink composition is preferably 0.05 to 1.00 mass %, 0.06 to 0.90 mass %, 0.07 to 0.80 mass %, 0.08 to 0.70 mass %, 0.09 to 0.60 mass %, or 0.10 to 0.50 mass % with respect to the total amount of the ink jet ink composition. When the total amount of the alkylene oxide adduct of (poly)glycerin is within the above range, the ejection stability of the ink jet ink composition tends to be further improved.

### 2.3. Water

The ink jet ink composition of the present embodiment contains water. In addition to the water contained in the dye composition, water may be further added. The water is not particularly limited, and may be, for example, pure water or ion-exchanged water. The content of water is preferably 60 to 90 mass % or 65 to 85 mass % with respect to the total amount of the ink jet ink composition. When the content of water is within the above range, the ejection stability of the ink jet ink composition tends to be further improved.

### 2.4. Other Additives

The ink jet ink composition of the present embodiment may contain additives other than the above-described compounds. Other additives are not particularly limited, and examples thereof include moisturizing agents, pH adjusters, dissolution aids, viscosity modifiers, antioxidants, preservatives, corrosion inhibitors, and chelating agents. The moisturizing agent is not particularly limited, and examples thereof include sorbitol, propylene glycol, ethylene glycol, glycerin, and diglycerin. The pH adjuster is not particularly limited, and examples thereof include triisopropanolamine, triethanolamine, and diethanolisopropanolamine.

The content of the other additives is not particularly limited, but is, for example, 0.1 to 30.0 mass % with respect to the total amount of the ink jet ink composition. The content of the moisturizing agent is not particularly limited, but is, for example, 5.0 to 30.0 mass % or 15.0 to 30.0 mass % with respect to the total amount of the ink jet ink composition.

### 2.5. Method of Producing Ink Jet Ink Composition

The ink jet ink composition can be prepared by mixing the individual components in any order and, as necessary, removing impurities, foreign substances, and the like by performing filtration or the like. As a method of mixing the individual components, a method of sequentially adding each component into a container equipped with a stirring apparatus such as a mechanical stirrer or a magnetic stirrer and stirring and mixing the mixture is used. Examples of the filtration method include centrifugal filtration and filter filtration.

### 3. Method of Forming Recorded Material

A method of forming a recorded material of the present embodiment includes: an ink jet recording step of ejecting the ink jet ink composition of the present embodiment from an ink jet head to cause the ink jet ink composition to adhere to an intermediate recording medium; a dye adhering step of superimposing a recording surface of the intermediate recording medium on a material to be dyed to obtain a laminate and heating the laminate at 150 to 220° C. to sublimate the water-insoluble dye contained in the ink jet ink composition and cause the sublimated water-insoluble dye to adhere to the material to be dyed; and a recorded material obtaining step of removing the intermediate recording medium from the laminate after the dye adhering step to obtain a recorded material which is the dyed material to which the water-insoluble dye has adhered. Since the ink jet ink composition of the present embodiment is excellent in ejection stability and storage stability at a high temperature, it is possible to accurately eject the ink jet ink composition to a recording medium even after the ink jet ink composition is stored in the ink jet head in a high-temperature environment. That is, a desired image tends to be accurately recorded on the material to be dyed. Hereinafter, each step which can be included in the method of forming the recorded material of the present embodiment will be described in detail.

### 3.1. Ink Jet Recording Step

In the ink jet recording step, the ink jet ink composition of the present embodiment is ejected from the ink jet head to adhere to the intermediate recording medium. An image to be transferred to the material to be dyed, described later, is printed on the intermediate recording medium.

The intermediate recording medium is not particularly limited, and examples thereof include commercially available sublimation transfer paper, and specific examples thereof include DS TRANSFER MULTI PURPOSE (manufactured by Seiko Epson Corporation) and the like.

Examples of the ink jet head include a piezoelectric ink jet head using a piezoelectric element whose volume changes when a voltage is applied, and a thermal ink jet head which ejects ink by generating bubbles in the ink by heating, but the piezoelectric ink jet head is preferable.

Examples of the ink jet head include a line head which performs recording by a line method and a serial head which performs recording by a serial method.

In the line method using the line head, for example, an ink jet head having a width equal to or larger than the recording width of the intermediate recording medium is fixed to the recording apparatus. Then, an image is recorded on the intermediate recording medium by moving the intermediate recording medium in a sub-scanning direction (the transport direction of the intermediate recording medium) and ejecting ink droplets from the nozzles of the ink jet head in conjunction with this movement.

In the serial method using the serial head, for example, an ink jet head is mounted on a carriage which can move in the width direction of the intermediate recording medium. An image is recorded on the intermediate recording medium by moving the carriage in a main scanning direction (the width direction of the intermediate recording medium) and ejecting ink droplets from the nozzles of the ink jet head in conjunction with this movement.

### 3.2. Dye Adhering Step

In the dye adhering step, the recording surface of the intermediate recording medium is superimposed on the material to be dyed to obtain a laminate, and the laminate is heated at 150 to 220° C. to sublimate the water-insoluble dye contained in the ink jet ink composition and cause the water-insoluble dye to adhere to the material to be dyed. The dye adhering step is performed after the ink jet recording step, and the image to be transferred to the material to be dyed, described later, has been printed on the recording surface of the intermediate recording medium in the dye adhering step.

In obtaining the laminate, the recording surface of the intermediate recording medium and the material to be dyed may be pressed against each other. Thus, when the water-insoluble dye is sublimated, the sublimated water-insoluble dye tends to easily adhere to the material to be dyed. The heating of the laminate may be performed after the laminate is obtained, or may be performed at the same time as the recording surface of the intermediate recording medium and the material to be dyed are superimposed. The temperature at which the laminate is heated is preferably 155 to 215° C., more preferably 160 to 210° C.

The material to be dyed to which the sublimated water-insoluble dye adheres preferably has a resin layer on the surface thereof, and more preferably has a polyester resin layer on the surface thereof. The material to be dyed is not particularly limited, and examples thereof include fabric, paper, and ceramic. When the material to be dyed does not have a resin layer on the surface thereof, a resin layer forming step of providing a resin layer on the surface of the material to be dyed may be performed before the dye adhering step. In this manner, it is possible to suitably perform the method of forming a recorded material of the present embodiment on various materials to be dyed.

### 3.3 Recorded Material Obtaining Step

In the recorded material obtaining step, after the dye adhering step, the intermediate recording medium is removed from the laminate to obtain a recorded material which is a dyed material to which the water-insoluble dye has adhered. The image recorded on the intermediate recording medium has been transferred to the recorded material obtained in this manner. The method of removing the intermediate recording medium from the laminate is not particularly limited, and examples thereof include a method of peeling the intermediate recording medium from the laminate.

### 4. Ink Jet Recording Apparatus

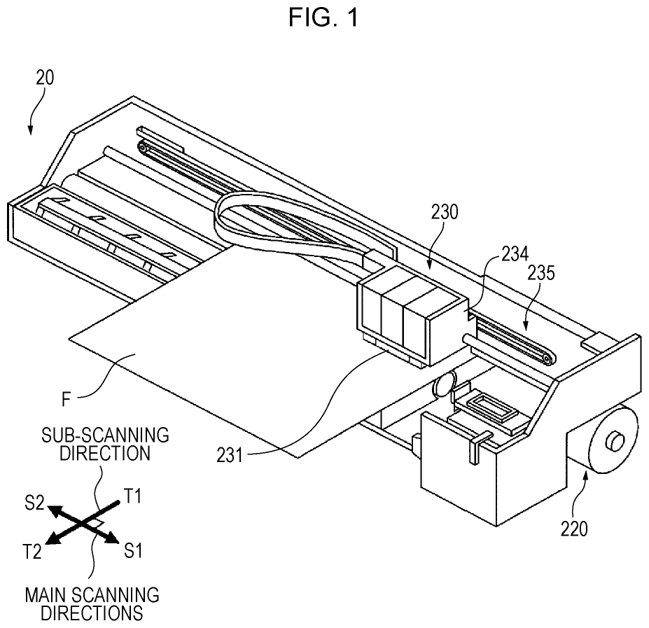

FIG. 1 is a perspective view of a serial printer as an example of an ink jet apparatus. As shown in FIG. 1, a serial printer 20 is provided with a transport portion 220 and a recording portion 230. The transport portion 220 transports a recording medium F fed to the serial printer 20 to the recording portion 230, and discharges the recording medium after recording to the outside of the serial printer 20. Specifically, the transport portion 220 has feed rollers and transports the fed recording medium F in a sub-scanning direction T2.

The recording portion 230 is provided with a carriage 234 on which an ink jet head 231 having nozzles which eject the ink composition onto the recording medium F sent from the transport portion 220 is mounted, and a carriage movement mechanism 235 which moves the carriage 234 in main scanning directions S1 and S2 of the recording medium F.

In the case of the serial printer 20, a head having a length smaller than a width of the recording medium is provided as the ink jet head 231, and as the head 231 moves, recording is performed in a plurality of passes (multi-pass). In the serial printer 20, the ink jet head 231 is mounted on the carriage 234, which moves in a predetermined direction, and ejects the ink composition onto the recording medium F while moving along with the movement of the carriage 234. As a result, recording is performed in two or more passes (multi-pass). The passes are also referred to as main scanning. Sub-scanning, in which the recording medium is transported, is performed between the passes. That is, main scanning and sub-scanning are alternately carried out.

The ink jet apparatus of the present embodiment is not limited to the above serial printer, and may be the above-described line printer. The line printer is a printer which performs recording on a recording medium by one scanning using a line head which is an ink jet head having a length equal to or greater than a recording width of the recording medium.

### EXAMPLES

The present disclosure will be described below more specifically with reference to Examples and Comparative Examples. The present disclosure is not limited by the following Examples. Unless otherwise specified, each operation in Examples was performed in an environment at room temperature (25° C.) and 1 atm.

### 1. Preparation of Dye Composition

### Example 1

The dye Disperse Red 60 (15 parts), DISPERBYK-2015 (18.75 parts, solid content concentration: 40 mass %), SANNIX GP-250 (0.3 parts), BYK-1770 (0.05 parts), and pure water (balance) were mixed and stirred to prepare 100 parts by mass of a mixed liquid. Zirconia beads (1 mm) and the mixed liquid were put into a 100 ml container, and the container was set in a rocking mill RM-05 (manufactured by SEIWA GIKEN Co., Ltd.). Then, dispersion treatment was performed for 4 hours to obtain a dispersion-treated mixed liquid. A mesh filter #100 was attached to the container, and the dispersion-treated mixed liquid was filtered. Thereafter, zirconia beads (0.1 mm) and the filtered mixed liquid were put into a 100 ml container, and the container was set in a rocking mill RM-05 (manufactured by SEIWA GIKEN Co., Ltd.). Dispersion treatment was performed for 4 hours to obtain a redispersion-treated mixed liquid. A mesh filter #400 was attached to the container, and the redispersion-treated mixed liquid was filtered to obtain a dye composition of Example 1 (hereinafter, also referred to as “dye composition e1”).

### Examples 2 to 12

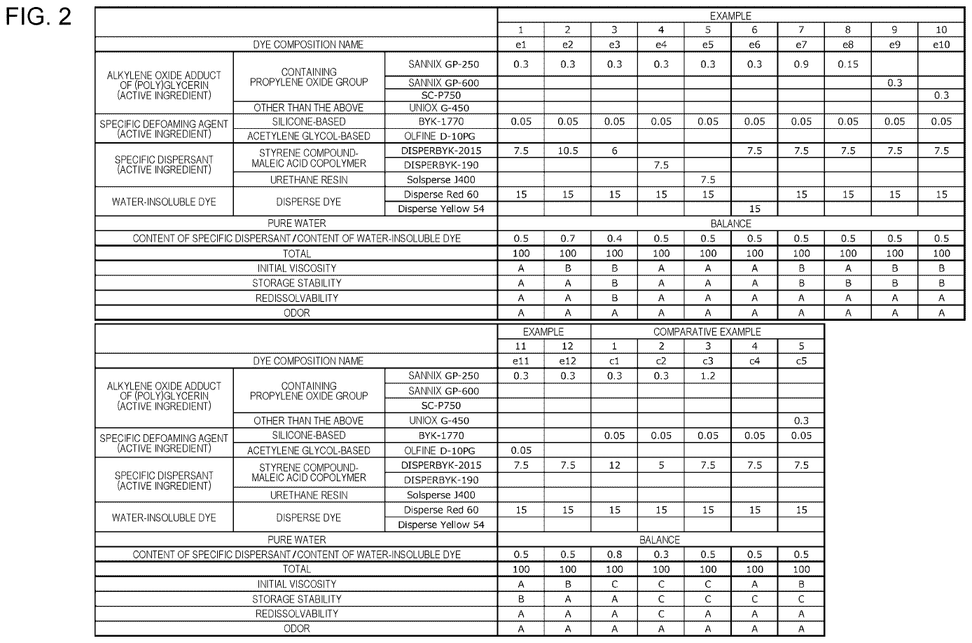

Dye compositions of Examples 2 to 12 (hereinafter, also referred to as “dye compositions e2 to e12”, respectively) were obtained in the same manner as in Example 1 except that the composition was changed as shown in FIG. 2.

### Comparative Examples 1 to 5

Dye compositions of Comparative Examples 1 to 5 (hereinafter, referred to as “dye compositions c1 to c5”, respectively) were obtained in the same manner as in Example 1 except that the composition was changed as shown in FIG. 2.

The numerical value of each component shown in each example in FIG. 2 represents mass % unless otherwise specified. The mass % of each of the alkylene oxide adducts of (poly)glycerin, the specific defoaming agents, and the specific dispersants represents a solid content concentration. The individual components in FIG. 2 are as follows.
SANNIX GP-250: a propylene oxide adduct of glycerin in which the average number of moles of propylene oxide groups added is 3 moles, manufactured by Sanyo Chemical Industries, Ltd.
SANNIX GP-600: a propylene oxide adduct of glycerin in which the average number of moles of propylene oxide groups added is 9 moles, manufactured by Sanyo Chemical Industries, Ltd.
SC-P750: a propylene oxide adduct of diglycerin in which the average number of moles of propylene oxide groups added is 9 moles, manufactured by Sakamoto Yakuhin Kogyo Co., Ltd.
UNIOX G-450: an ethylene oxide adduct of glycerin in which the average number of moles of ethylene oxide groups added is 8 moles, manufactured by Kao Corporation
BYK-1770: manufactured by BYK Japan KK
OLFINE D-10PG: manufactured by Nissin Chemical Industry Co., Ltd.
DISPERBYK-2015: manufactured by BYK Japan KK
DISPERBYK-190: manufactured by BYK Japan KK
Solsperse J400: manufactured by Lubrizol Japan Ltd.
Disperse RED 60: manufactured by ARIMOTO CHEMICAL Co., Ltd., having a molecular weight of 331
Disperse Yellow 54: manufactured by ARIMOTO CHEMICAL Co., Ltd., having a molecular weight of 289

### 2. Preparation of Ink Jet Ink Composition

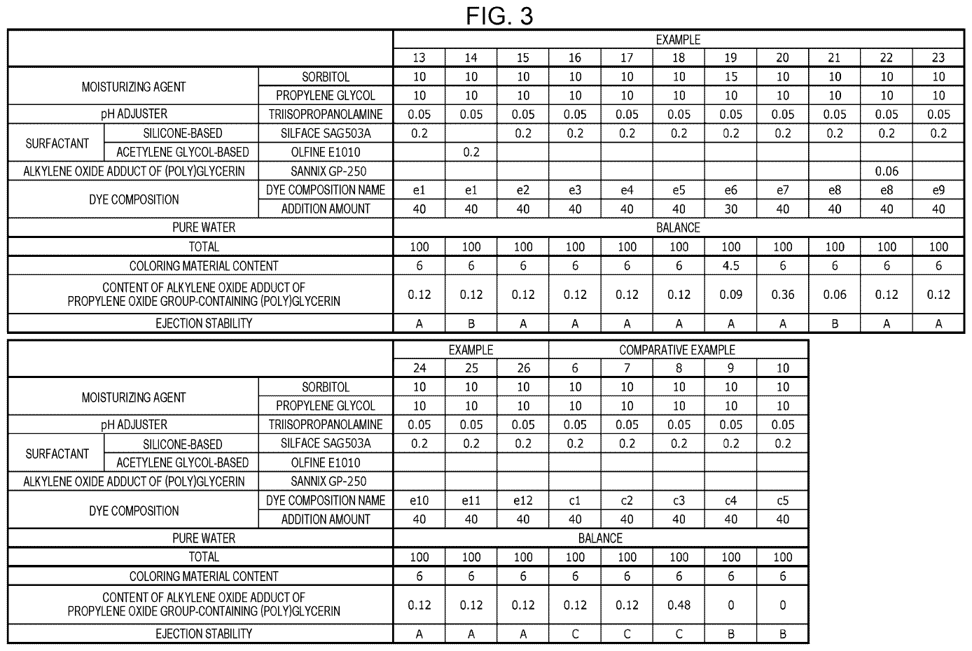

The ink jet ink composition used in each example was obtained by putting each component into a mixture tank which was a stainless steel container so as to have the composition described in FIG. 3, mixing and stirring the mixture at room temperature, and, as necessary, removing impurities, foreign substances, and the like by performing filtration or the like. Note that the numerical value of each component shown in each example in the figure represents mass % unless otherwise specified. The mass % of each of the surfactants represents a solid content concentration. The individual components in FIG. 3 are as follows.
SILFACE SAG503A: manufactured by Nissin Chemical Industry Co., Ltd.
OLFINE E1010: manufactured by Nissin Chemical Industry Co., Ltd.

### 3. Evaluation Results

### 3.1. Initial Viscosity

Each of the dye compositions of Examples 1 to 12 and Comparative Examples 1 to 5 was allowed to stand for 1 day after production. Thereafter, the viscosities of the dye compositions of Examples 1 to 12 and Comparative Examples 1 to 5 at a shear rate of 200 s⁻¹ were measured using a rheometer MCR702 (trade name) manufactured by Anton Paar GmbH, and evaluated based on the following evaluation criteria. The evaluation results are shown in FIG. 2. In a case where a dye composition evaluated as good for initial viscosity is applied to an ink jet ink composition, the ink jet ink composition tends to have excellent ejection stability.

### Evaluation Criteria

A: The viscosity is less than 5 mPa·s.
B: The viscosity is 5 mPa's or more and less than 5.5 mPa·s.
C: The viscosity is 5.5 mPa's or more.

### 3.2. Storage Stability

Each of the dye compositions (30 g) of Examples 1 to 12 and Comparative Examples 1 to 5 was put into a 50 cc screw tube and allowed to stand in a thermostatic chamber at 60° C. for 5 days. Thereafter, the dye composition was taken out and allowed to stand in a room-temperature environment and thereby naturally cooled to room temperature. The viscosities of the dye compositions of Examples 1 to 12 and Comparative Examples 1 to 5 thus obtained at a shear rate of 200 s⁻¹ were measured using the rheometer MCR702 (trade name) manufactured by Anton Paar GmbH. Then, the thickening ratio with respect to the initial viscosity was calculated and evaluated based on the following evaluation criteria. The evaluation results are shown in FIG. 2. The thickening ratio is calculated by the following formula:

$$Thickening ratio ( \% ) = ( viscosity after standing for 5 days - initial viscosity ) \text{} / initial viscosity \times 100$$

### Evaluation Criteria

A: The thickening ratio is more than −3% and less than 3%.
B: The thickening ratio is more than −5% and −3% or less, or 3% or more and less than 5%.
C: The thickening ratio is −5% or less, or 5% or more.

### 3.3. Redissolvability

Three droplets of each of the dye compositions of Examples 1 to 12 and Comparative Examples 1 to 5 were dropped on a PET film (Lumirror #75-S10 (trade name), manufactured by Toray Industries, Inc.), and the dye composition was spread on the PET film with a bar coater #3. The PET film thus obtained was allowed to stand in a thermostatic chamber at 40° C. for 5 hours and then immersed in pure water, and the coating film was visually inspected for dissolution and evaluated based on the following evaluation criteria. The evaluation results are shown in FIG. 2.

### Evaluation Criteria

A: The coating film dissolves in pure water, and the color on the PET film becomes lighter.
B: The coating film peels off from the PET film, but does not dissolve in pure water.
C: The coating film does not peel off and does not dissolve in pure water.

### 3.4. Odor

Each of the dye compositions (30 g) of Examples 1 to 12 and Comparative Examples 1 to 5 was put into a 50 cc screw tube, and five people smelled the odor near the opening of the screw tube to judge the odor. The judgment results were evaluated based on the following evaluation criteria. The evaluation results are shown in FIG. 2.

### Evaluation Criteria

A: Five people judge the dye composition as “no odor”.
B: Two to four people judge the dye composition as “no odor”.
C: One or less people judge the dye composition as “no odor”.

### 3.5. Ejection Stability

Each of the ink jet ink compositions of Examples 13 to 26 and Comparative Examples 6 to 10 was charged into an ink jet head of an ink jet printer (PX-G930 (trade name), manufactured by Seiko Epson Corporation), and was allowed to stand for 20 minutes in a state where a head cap of an ink cartridge was opened. Thereafter, cleaning of the ink jet head was performed once, a solid fill pattern was printed on 20 sheets, and then a nozzle check pattern was printed. Then, the nozzles were inspected for misfiring and misdirection. The observation results were evaluated based on the following evaluation criteria. The evaluation results are shown in FIG. 3. The test environment was at a temperature of 40° C. and a relative humidity of 20%.

### Evaluation Criteria

A: Of the 180 nozzles, there are no nozzles exhibiting misfiring or misdirection.
B: Of the 180 nozzles, there are 1 to 30 nozzles exhibiting misfiring or misdirection.
C: Of the 180 nozzles, there are 31 to 180 nozzles exhibiting misfiring or misdirection.

What is claimed is:

1. A dye composition comprising:
a water-insoluble dye;
a specific dispersant for dispersing the water-insoluble dye;
an alkylene oxide adduct of (poly)glycerin; and
water,
wherein the specific dispersant contains a copolymer of a styrene compound and maleic acid, or a urethane resin,
the alkylene oxide adduct of (poly)glycerin contains a propylene oxide group,
a ratio (B/A) of a content B of the specific dispersant to a content A of the water-insoluble dye is 0.40 to 0.75, and
a content of the alkylene oxide adduct of (poly)glycerin is 0.05 to 1.00 mass % with respect to a total amount of the dye composition.

2. The dye composition according to claim 1, wherein the alkylene oxide adduct of (poly)glycerin contains a compound represented by the following Formula 1; 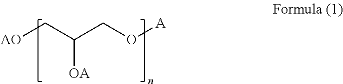
wherein a plurality of A are each independently a monovalent (poly)alkylene oxide group represented by the following Formula (2) or a hydrogen atom, at least one of the plurality of A is a monovalent (poly)alkylene oxide group represented by the following Formula (2), and n is a natural number, 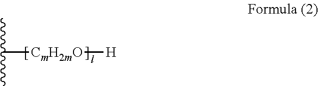
wherein m is each independently a natural number of 2 to 4, l is a natural number of 1 to 30, m in the plurality of A may be different from each other, and l in the plurality of A may be different from each other.

3. The dye composition according to claim 1, wherein the water-insoluble dye contains a disperse dye having a molecular weight of 500 or less or a solvent dye having a molecular weight of 500 or less.

4. The dye composition according to claim 1, wherein an average number of moles of the propylene oxide group added in the alkylene oxide adduct of (poly)glycerin is 9 moles or less.

5. The dye composition according to claim 1, further comprising a specific defoaming agent containing an acetylene glycol-based defoaming agent and/or a silicone-based defoaming agent,
wherein a content of the specific defoaming agent is 0.10 mass % or less with respect to the total amount of the dye composition.

6. A method of producing the dye composition according to claim 1, comprising dispersing a water-insoluble dye in water by mixing the water-insoluble dye, a specific dispersant for dispersing the water-insoluble dye, an alkylene oxide adduct of (poly)glycerin, and water.

7. An ink jet ink composition comprising the dye composition according to claim 1.

8. The ink jet ink composition according to claim 7, further comprising a silicone-based surfactant.

9. A method of forming a recorded material, comprising:
ejecting the ink jet ink composition according to claim 7 from an ink jet head to cause the ink jet ink composition to adhere to an intermediate recording medium;
superimposing a recording surface of the intermediate recording medium on a material to be dyed to obtain a laminate and heating the laminate at 150 to 220° C. to sublimate the water-insoluble dye contained in the ink jet ink composition and cause the sublimated water-insoluble dye to adhere to the material to be dyed; and
removing the intermediate recording medium from the laminate after the dye adhering to obtain a recorded material which is the dyed material to which the water-insoluble dye has adhered.
